(19) United States
(12) Patent Application Publication
(10) Pub. No.: US 2008/0310446 A1
(43) Pub. Date: Dec. 18, 2008

(54) Provisioning Bandwidth For A Digital Media Stream

(76) Inventors: Thomas A. Bellwood, Austin, TX (US); Robert B. Chumbley, Round Rock, TX (US); Matthew F. Rutkowski, Pflugerville, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/761,817

(22) Filed: Jun. 12, 2007

(51) Int. Cl. H04J 3/16; H04J 3/22

(52) U.S. Cl. 370/468

(57) ABSTRACT

Provisioning bandwidth for a digital media stream, the digital media stream characterized by a bandwidth, including monitoring, by a media display device, a user's viewing behavior to create a user profile; transmitting, to a media server, the user profile; and responsive to receiving, by the media server, a user selection of a first channel: selecting, for transmission to the media display device, in dependence upon the user profile, at least one second channel; adapting a first portion of the bandwidth for transmission of the content of the first channel and a second, smaller portion of the bandwidth for transmission of the content of the second channel; and transmitting, multiplexed together in the digital media stream, the content of the first channel and the content of the second channel, the content of the second channel transmitted with a lower quality than the content of the first channel.

### BACKGROUND OF THE INVENTION

1. Field of the Invention

The field of the invention is data processing, or, more specifically, methods, apparatus, and products for provisioning bandwidth for a digital media stream.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is in provisioning bandwidth for a digital media stream. The delivery of real-time streamed content to users for viewing entails some special quality of service problems when the user chooses to switch between different content streams. When a user views real-time, live streamed content, it is expected that no significant delay be present in the stream, other than that injected by the broadcaster as a result of regulatory or similar considerations. Significant delays, particularly with regard to delivery of information which may have time based intrinsic value to the viewer, such as sports telecasts, stock market activity, and news, is highly undesirable. In a streamed media solution, content to be viewed is streamed within the allowable bandwidth to the viewer. Using the typical approach, when the viewer chooses to switch channels to a different piece of live content, a constantly pre-buffered stream but with a significant delay is made available to the user. There is also a further switching delay inherent between requests from the client and the content server. These delays make live broadcasts effectively no longer live. A typical television experience, with minimal switching delays, is not currently supportable.

### SUMMARY OF THE INVENTION

Methods, apparatus, and products for provisioning bandwidth for a digital media stream are disclosed, the digital media stream characterized by a bandwidth, are disclosed that include monitoring, by a media display device, a user's viewing behavior to create a user profile; transmitting, by the media display device to a media server, the user profile; and responsive to receiving, by the media server from the media display device, a user selection of a first channel: selecting, by the media server for transmission to the media display device, in dependence upon the user profile, at least one second channel; adapting by the media server a first portion of the bandwidth for transmission of the content of the first channel and a second, smaller portion of the bandwidth for transmission of the content of the second channel; and transmitting, multiplexed together in the digital media stream, by the media server to the media display device, the content of the first channel and the content of the second channel, the content of the second channel transmitted with a lower quality than the content of the first channel.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for provisioning bandwidth for a digital media stream according to embodiments of the present invention.

FIG. 2 sets forth a block diagram of automated computing machinery comprising an exemplary computer configured to operate as a media server in provisioning bandwidth for a digital media stream according to embodiments of the present invention.

FIG. 3 sets forth a block diagram of automated computing machinery comprising a further exemplary computer configured to operate as a digital media server for provisioning bandwidth for a digital media stream according to embodiments of the present invention.

FIG. 4 sets forth a flow chart illustrating an exemplary method for provisioning bandwidth for a digital media stream according to embodiments of the present invention.

FIG. 5 sets forth a flow chart illustrating a further exemplary method for provisioning bandwidth for a digital media stream according to embodiments of the present invention.

### DETAILED DESCRIPTION OF EXEMPLARY EMBODIMENTS

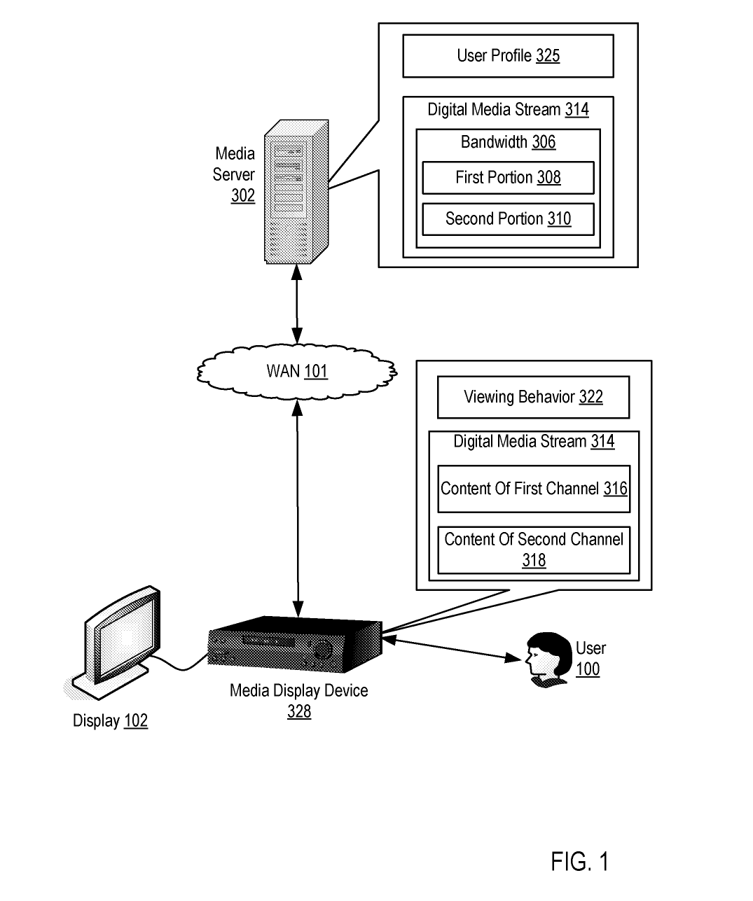

Exemplary methods, apparatus, and products for provisioning bandwidth for a digital media stream in accordance with the present invention are described with reference to the accompanying drawings, beginning with FIG. 1. FIG. 1 sets forth a network diagram of a system for provisioning bandwidth for a digital media stream according to embodiments of the present invention. A digital media stream is multimedia content that is delivered to a media display device during playback. A media display device is any device capable of multimedia playback. A media display device may be implemented, for example, as a set top box, personal video recorder, or as part of a Digital Television (‘DTV’). The digital media stream (314) of FIG. 1 is characterized by a bandwidth (306).

The system of FIG. 1 includes a media display device (328) that monitors a user's (100) viewing behavior (322) to create a user profile (325). The exemplary media display device (328) of FIG. 1 also transmits, to a media server (302), the user profile (325). A media server is any device that transmits multimedia content. The media server (302) of FIG. 1, responsive to receiving from the media display device (328) a user selection of a first channel, provisions the bandwidth (306) for the digital media stream (314) according to embodiments of the present invention by selecting, for transmission to the media display device (328), in dependence upon the user profile (325), at least one second channel. The exemplary media server of FIG. 1 also adapts a first portion (308) of the bandwidth (306) for transmission of the content (316) of the first channel and a second, smaller portion (310) of the bandwidth (306) for transmission of the content (318) of the second channel. The exemplary media server of FIG. 1 also transmits, multiplexed together in the digital media stream (314), to the media display device (328), the content (316) of the first channel and the content (318) of the second channel, the content (318) of the second channel transmitted with a lower quality than the content of the first channel. The media server may transmit the content of both channels over any data communications network. In the system of FIG. 1, for example, the media server transmits the content of both channels over the wide area network (‘WAN’) (101).

The arrangement of servers and other devices making up the exemplary system illustrated in FIG. 1 are for explanation, not for limitation. Data processing systems useful according to various embodiments of the present invention may include additional media servers, media display devices, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), RTP (Real-time Transport Protocol), and RTCP (Real-time Control Protocol), and others as will occur to those of skill in the art. Various embodiments of the present invention may be implemented on a variety of hardware platforms in addition to those illustrated in FIG. 1.

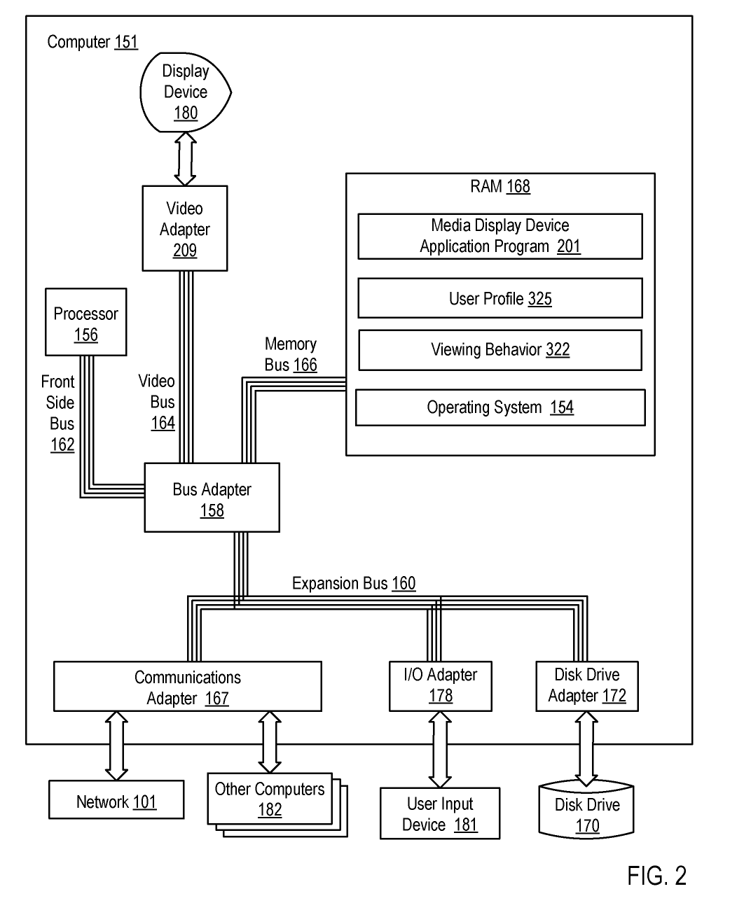

Provisioning bandwidth for a digital media stream in accordance with the present invention is generally implemented with computers, that is, with automated computing machinery. In the system of FIG. 1, for example, the media server and the media display device are implemented to some extent at least as computers. For further explanation, therefore, FIG. 2 sets forth a block diagram of automated computing machinery comprising an exemplary computer (151) configured to operate as a media server in provisioning bandwidth for a digital media stream according to embodiments of the present invention. The computer (151) of FIG. 2 includes at least one computer processor (156) or ‘CPU’ as well as random access memory (168) (‘RAM’) which is connected through a high speed memory bus (166) and bus adapter (158) to processor (156) and to other components of the computer.

Stored in RAM (168) is media display device application program (201), a module of computer program instructions that causes the computer (151) in the example of FIG. 2 to operate as a media display device in provisioning bandwidth for a digital media stream according to embodiments of the present invention by monitoring a user's viewing behavior (322) to create a user profile (325). The media display device application program (201) may also be configured to transmit, to a media server, the user profile (325).

Also stored in RAM (168) is an operating system (154). Operating systems useful in computers according to embodiments of the present invention include UNIX™, Linux™, Microsoft Vista™, Microsoft XP™, AIX™, IBM's i5/OS™, and others as will occur to those of skill in the art. Operating system (154) and the media server application program (202) in the example of FIG. 2 are shown in RAM (168), but many components of such software typically are stored in non-volatile memory also, for example, on a disk drive (170).

The computer (151) of FIG. 2 includes a bus adapter (158), a computer hardware component that contains drive electronics for the high speed buses, the front side bus (162), the video bus (164), and the memory bus (166), as well as drive electronics for the slower expansion bus (160). Examples of bus adapters useful for provisioning bandwidth for a digital media stream according to embodiments of the present invention include the Intel Northbridge, the Intel Memory Controller Hub, the Intel Southbridge, and the Intel I/O Controller Hub. Examples of expansion buses useful for provisioning bandwidth for a digital media stream according to embodiments of the present invention include Industry Standard Architecture (‘ISA’) buses and Peripheral Component Interconnect (‘PCI’) buses.

The computer (151) of FIG. 2 includes disk drive adapter (172) coupled through expansion bus (160) and bus adapter (158) to processor (156) and other components of the computer (151). Disk drive adapter (172) connects non-volatile data storage to the computer (151) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The example computer (151) of FIG. 2 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The example computer (151) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (151) of FIG. 2 includes a communications adapter (167) for data communications with other computers (182) and for data communications with a data communications network (101). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for provisioning bandwidth for a digital media stream according to embodiments of the present invention include modems for wired dial-up communications, Ethernet (IEEE 802.3) adapters for wired data communications network communications, and 802.11 adapters for wireless data communications network communications.

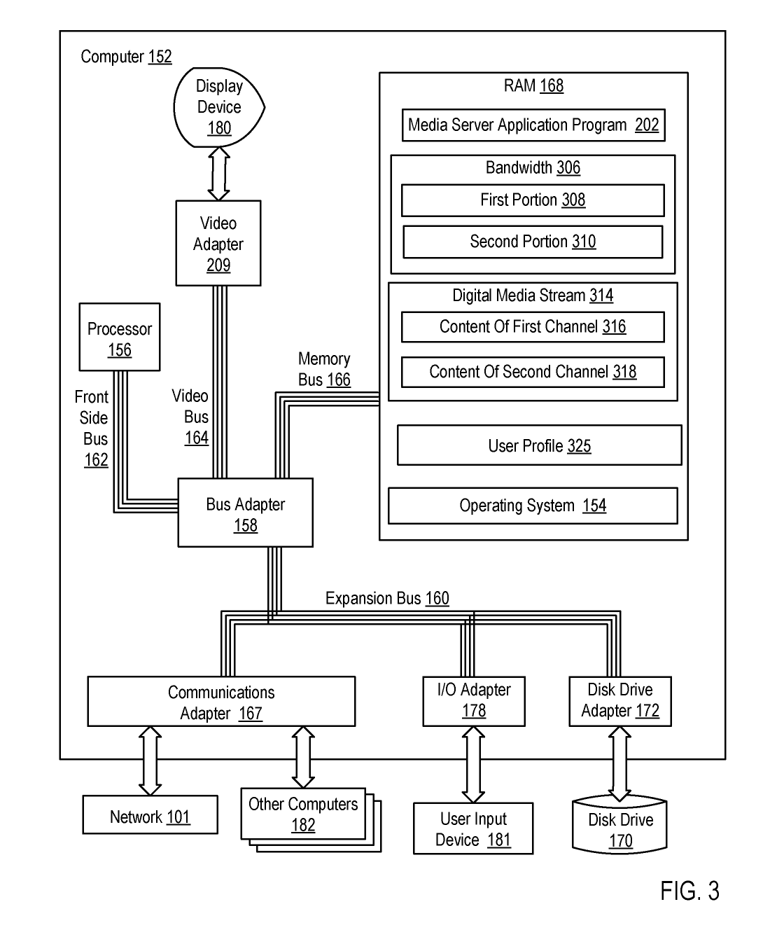

For further explanation FIG. 3 sets forth a block diagram of automated computing machinery comprising a further exemplary computer (152) configured to operate as a digital media server for provisioning bandwidth for a digital media stream according to embodiments of the present invention. The example computer (152) of FIG. 3 includes several components that are structured and operate similarly as do parallel components of the computer (151 on FIG. 2), having the same drawing reference numbers, as described above with reference to FIG. 2: At least one computer processor (156), frontside bus (162), RAM (168), high speed memory bus (166), bus adapter (158), video adapter (209), video bus (164), expansion bus (160), communications adapter (167), I/O adapter (178), disk drive adapter (172), an operating system (154), and so on.

Stored in RAM (168) is media server application program (202), a module of computer program instructions that causes the computer (152) in the example of FIG. 2 to operate as a media server and provision bandwidth for a digital media stream. The digital media stream (314) of FIG. 2 is characterized by a bandwidth (306). The media server application program (202) may be configured to provision the bandwidth (306) for the digital media stream (314) according to embodiments of the present invention such that, responsive to receiving, from a media display device, a user selection of a first channel, the media server application program (202) selects, for transmission to the media display device, in dependence upon a user profile (325), at least one second channel. The media server application program (202) may also be configured to adapt a first portion (308) of the bandwidth (306) for transmission of the content (316) of a first channel and a second, smaller portion (310) of the bandwidth (306) for transmission of the content (318) of the second channel. The media server application program (202) may also be configured to transmit, multiplexed together in the digital media stream (314), to the media display device (328), the content (316) of the first channel and the content (318) of the second channel, the content (318) of the second channel transmitted with a lower quality than the content of the first channel.

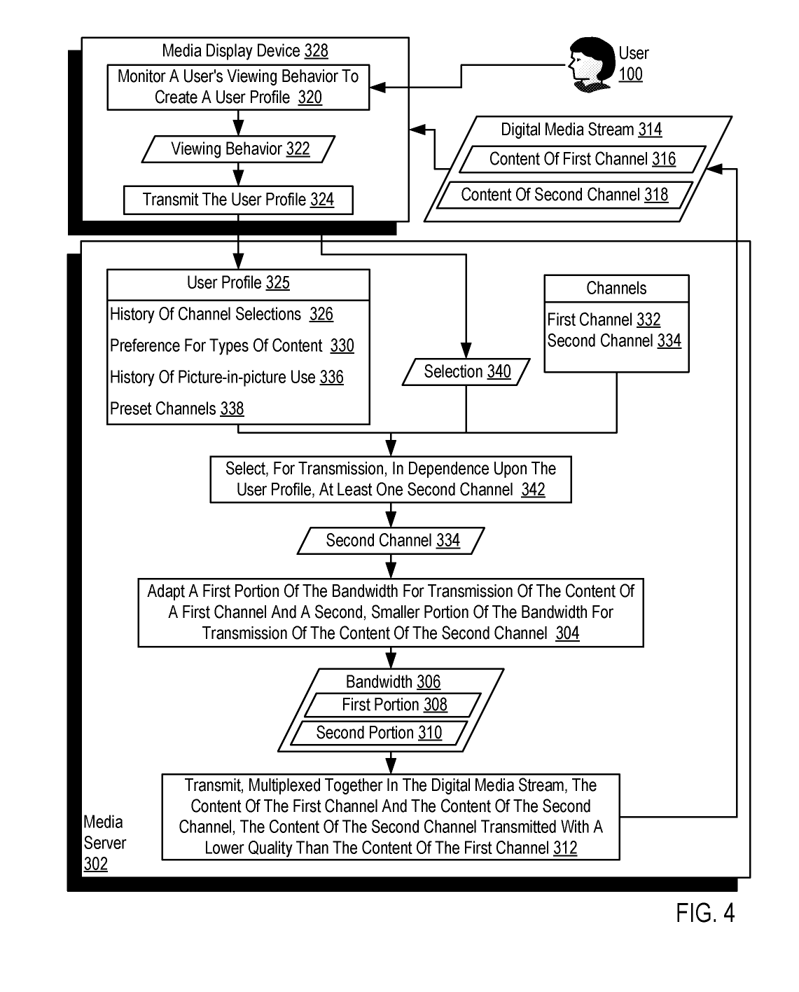

For further explanation, FIG. 4 sets forth a flow chart illustrating an exemplary method for provisioning bandwidth for a digital media stream according to embodiments of the present invention. A digital media stream is multimedia content that is delivered to a media playback device during playback. In the method of FIG. 4 for example, the digital media stream may be a VOIP stream or an IPTV stream. VOIP stands for ‘Voice Over Internet Protocol,’ a generic term for routing speech over an IP-based data communications network. The speech data flows over a general-purpose packet-switched data communications network, instead of traditional dedicated, circuit-switched voice transmission lines. Protocols used to carry voice signals over the IP data communications network are commonly referred to as ‘Voice over IP’ or ‘VOIP’ protocols. VOIP traffic may be deployed on any IP data communications network, including data communications networks lacking a connection to the rest of the Internet, for instance on a private building-wide local area data communications network or ‘LAN.’

Many protocols are used to effect VOIP. The two most popular types of VOIP are effected with the IETF's Session Initiation Protocol (‘SIP’) and the ITU's protocol known as ‘H.323.’ SIP clients use TCP and UDP port 5060 to connect to SIP servers. SIP itself is used to set up and tear down calls for speech transmission. VOIP with SIP then uses RTP for transmitting the actual encoded speech. Similarly, H.323 is an umbrella recommendation from the standards branch of the International Telecommunications Union that defines protocols to provide audio-visual communication sessions on any packet data communications network.

IPTV stands for ‘Internet Protocol Television,’ a generic term for routing digital television content over an IP-based data communications network. The digital television content flows over a general-purpose, packet-switched data communications network, instead of traditional television cables, satellite transmission technology, or terrestrial antennas. IPTV traffic may be deployed on any IP data communications network, including data communications networks lacking a connection to the rest of the Internet, for instance on a private building-wide local area data communications network or ‘LAN.’

IPTV content is typically compressed using either a MPEG-2 or a MPEG-4 codec and then sent in an MPEG transport stream delivered via IP Multicast. IP Multicast is a method in which information can be sent to multiple media playback devices at the same time. IPTV may be effected by using Internet Group Management Protocol (‘IGMP’) to connect to a multicast stream, a digital television channel, and to change from one multicast stream to another. IGMP is the communications protocol used to manage the membership of Internet Protocol multicast groups. IGMP is used by IP hosts and adjacent multicast routers to establish multicast group memberships.

In the method of FIG. 4, the exemplary digital media stream (314) is characterized by a bandwidth (306). Bandwidth is a measure of the amount of information or data that can be sent by a media server to a media display device over a network connection in a given period of time, that is, bandwidth is a measure of data rate. Bandwidth is usually measured in bits per second (‘bps’), kilobits per second (‘kbps’), or megabits per second (‘mbps’).

The method of FIG. 4 includes monitoring (320), by a media display device (328), a user's (100) viewing behavior (322) to create a user profile (325). The media display device may monitor a user's viewing behavior by gathering data describing a user's preferences, such as for example, the types of content the user prefers, the channels the user typically selects at specific times on specific days of the week, the channels the user typically selects for picture-in-picture use, the channels the user has preset in a remote control associated with the media display device, and so on as will occur to those of skill in the art. The types of content the user prefers may include sports, movies, situation comedies, and so on. The channels the user typically selects at specific times on specific days of the week, for example, may indicate for example, that the user always selects channel 25 on Monday nights at 7:00 pm. The channels the user typically selects for picture-in-picture use may indicate, for example, that the user typically selects channel 2 and channel 23 for picture-in-picture use. The media display device may create a user profile that includes any number of the user's viewing behaviors. The user profile (325) of FIG. 4, for example, includes a history of user channel selections (326), each user channel selection characterized by a day of the week and a time; the user's preference for types of content (330), a history of the user's picture-in-picture use (336), and the user's preset channels on a remote control (338).

The method of FIG. 4 also includes transmitting (324), by the media display device (328) to the media server (302), the user profile (328). The media display device (328) may transmit the user profile to the media display server over a data communications network through any number of data communications protocols including, for example, TCP (Transmission Control Protocol), IP (Internet Protocol), HTTP (HyperText Transfer Protocol), WAP (Wireless Access Protocol), HDTP (Handheld Device Transport Protocol), RTP (Real-time Transport Protocol), and RTCP (Real-time Control Protocol), and others as will occur to those of skill in the art.

Responsive to receiving, by the media server (302) from the media display device, a user selection (340) of a first channel (322), the exemplary media server (342) of FIG. 4 selects (342), for transmission to the media display device (328), in dependence upon the user profile (325), at least one second channel (334). When a user selects a channel at the media display device, the media display device transmits the selection to the media server. The media server, in response to receiving the selection of the first channel, may be configured to select at least one second channel in various ways. The media server may, for example, be configured to compare real-time data, such as the current time, the current date, and so on, to the user profile to determine what channel, other than the first channel, a user is likely to select. If the media server receives the selection of the first channel, channel 4, at Monday night at 7:00 pm, for example, and the user profile indicates that the user typically selects channel 22 on Monday nights at 7:00 pm, the media server will select channel 22. Alternatively, the media server may be configured to identify, in the user profile, the user's most selected channel as the second channel. If the media server receives the selection of the first channel, channel 4, and the user profile indicates that the user's most selected channel is channel 25, the media server will select channel 25 as the second channel. Although only two ways of selecting at least one second channel are described here, readers of skill in the art will immediately recognize that selecting at least one second channel may be implemented in numerous other ways, and each such implementation is well within the scope of present invention.

The method of FIG. 4 includes adapting (304) by a media server (302) a first portion (308) of the bandwidth (306) for transmission of the content (316) of the first channel (332) and a second, smaller portion (310) of the bandwidth (306) for transmission of the content (318) of the second channel (334). The media server (302) of FIG. 4 is configured with channels (332, 334). Each channel represents a stream of digital media. Although only two channels are depicted in the method of FIG. 4, readers of skill in the art will realize that media servers that provision bandwidth for a digital media stream in accordance with embodiments of the present invention may include any number of channels.

Adapting (304) a first portion (308) of the bandwidth (306) for transmission of the content (316) of the first channel (332) and a second, smaller portion (310) of the bandwidth (306) for transmission of the content (318) of the second channel (334) may be carried out by calculating each portion in dependence upon the bandwidth and a percentage of the bandwidth to dedicate to each channel. If the bandwidth is 1 mbps, for example, and the percentage of the bandwidth to dedicate to the first channel is 80%, then the first portion is 0.8 mbps, and the second portion is 0.2 mbps. Although provisioning bandwidth for a digital media stream is described here with respect to only two channels, one of skill in the art will immediately recognize that any number of channels may be used. If three channels are used, for example, the bandwidth is 1 mbps, and the bandwidth to dedicate to the first channel is 80%, then the remainder of the bandwidth, 0.2 mbps, may be dedicated to the second and third channels. The percentage of bandwidth to dedicate to each channel may be a static value, specified in computer memory in the media server or the percentage may be specified in a profile for each user.

The method of FIG. 4 also includes transmitting (312), multiplexed together in the digital media stream (314), by the media server (302) to the media display device (328), the content (316) of the first channel and the content (318) of the second channel, the content (318) of the second channel transmitted with a lower quality than the content of the first channel. The quality of content is a measure of the data rate at which the content of each channel is transmitted. That is, the higher the data rate, the higher the quality and vice versa. The data rate needed to transmit the content of each channel may be increased or decreased by varying any number of multimedia parameters, including for example, the level of compression of content, the resolution of the content, the sampling rate of the content, and so on as will occur to those of skill in the art. The media server may transmit (312) the content (316) of the first channel and the content (318) of the second channel by decreasing the data rate of the content of the second channel, increasing the data rate of the content of the first channel, or both. The media server (302) may transmit the content of the first channel and the content of the second channel over a data communications network using the Internet Protocol (‘IP’).

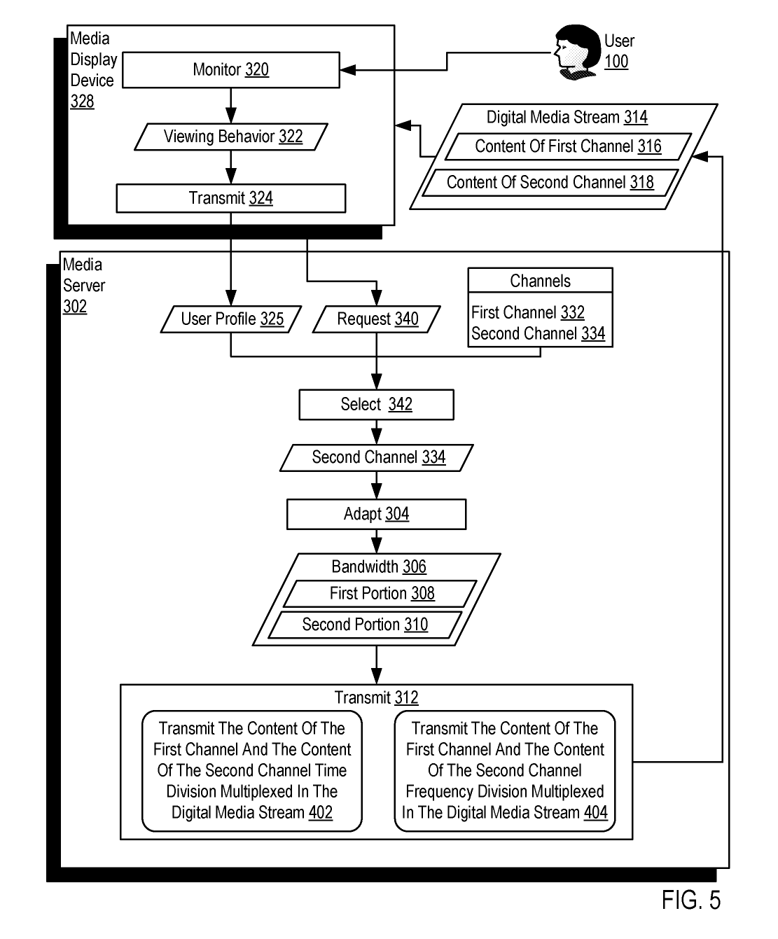

For further explanation, FIG. 5 sets forth a flow chart illustrating a further exemplary method for provisioning bandwidth for a digital media stream according to embodiments of the present invention. The method of FIG. 5 is similar to the method of FIG. 4, including, as it does, the media display device's (328) monitoring (320) a user's (100) viewing behavior (322) to create a user profile (325), the media display device's (328) transmitting (324) the user profile (325), the media server's (302) selecting (342) at least one second channel (334), the media server's (302), adapting (304) a first portion (308) of the bandwidth (306) for transmission of the content (316) of the first channel and a second, smaller portion (310) of the bandwidth (306) for transmission of the content (318) of the second channel, and the media server's (302), transmitting (312) the content (316) of the first channel and the content (318) of the second channel, all of which operate in a similar manner as described above.

In the method of FIG. 5, however, transmitting (312) the content (316) of the first channel and the content (318) of the second channel may be carried out by transmitting (402) the content (316) of the first channel and the content (318) of the second channel time division multiplexed in the digital media stream. Multiplexing is a process where multiple digital streams are combined into one signal. Time division multiplexing (‘TDM’) is a type of digital multiplexing in which two or more signals or bit streams appear to be transferred simultaneously as sub-channels in one communication channel, but are actually, physically taking turns on the channel. The time domain is divided into several recurrent timeslots of fixed length, one for each sub-channel. A sample, byte, or data block of a first sub-channel is transmitted during a first timeslot, a second sub-channel during a second timeslot, and so on. A TDM frame consists of one timeslot for each sub-channel. When the last timeslot for the last sub-channel is transmitted the cycle starts all over again with a new frame, starting with the second sample, byte or data block from the first sub-channel.

As an alternative to TDM, the media server may transmit (312) the content (316) of the first channel and the content (318) of the second channel by transmitting the content (316) of the first channel and the content of the second (318) channel frequency division multiplexed in the digital media stream. Frequency division multiplexing (‘FDM’) is a type of multiplexing where multiple baseband signals are modulated on different frequency carrier waves and added together to create a composite signal.

Exemplary embodiments of the present invention are described largely in the context of a fully functional computer system for provisioning bandwidth for a digital media stream. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of provisioning bandwidth for a digital media stream, the digital media stream characterized by a bandwidth, the method comprising:
monitoring, by a media display device, a user's viewing behavior to create a user profile;
transmitting, by the media display device to a media server, the user profile; and
responsive to receiving, by the media server from the media display device, a user selection of a first channel:
selecting, by the media server for transmission to the media display device, in dependence upon the user profile, at least one second channel;
adapting by the media server a first portion of the bandwidth for transmission of the content of the first channel and a second, smaller portion of the bandwidth for transmission of the content of the second channel; and
transmitting, multiplexed together in the digital media stream, by the media server to the media display device, the content of the first channel and the content of the second channel, the content of the second channel transmitted with a lower quality than the content of the first channel.

2. The method of claim 1 wherein the user profile further comprises:
a history of user channel selections, each user channel selection characterized by a day of the week and a time;
the user's preference for types of content;
a history of the user's picture-in-picture use; and
the user's preset channels on a remote control.

3. The method of claim 1 wherein the digital media stream further comprises a VoIP stream.

4. The method of claim 1 wherein the digital media stream further comprises an IPTV stream.

5. The method of claim 1 wherein transmitting the content of the first channel and the content of the second channel further comprises transmitting the content of the first channel and the content of the second channel time division multiplexed in the digital media stream.

6. The method of claim 1 wherein transmitting the content of the first channel and the content of the second channel further comprises transmitting the content of the first channel and the content of the second channel frequency division multiplexed in the digital media stream.

7. Apparatus for provisioning bandwidth for a digital media stream, the digital media stream characterized by a bandwidth, the apparatus comprising a computer processor, a computer memory operatively coupled to the computer processor, the computer memory having disposed within it computer program instructions capable of:
monitoring, by a media display device, a user's viewing behavior to create a user profile;
transmitting, by the media display device to a media server, the user profile; and
responsive to receiving, by the media server from the media display device, a user selection of a first channel:
selecting, by the media server for transmission to the media display device, in dependence upon the user profile, at least one second channel;
adapting by the media server a first portion of the bandwidth for transmission of the content of the first channel and a second, smaller portion of the bandwidth for transmission of the content of the second channel; and
transmitting, multiplexed together in the digital media stream, by the media server to the media display device, the content of the first channel and the content of the second channel, the content of the second channel transmitted with a lower quality than the content of the first channel.

8. The apparatus of claim 7 wherein the user profile further comprises:
a history of user channel selections, each user channel selection characterized by a day of the week and a time;
the user's preference for types of content;
a history of the user's picture-in-picture use; and
the user's preset channels on a remote control.

9. The apparatus of claim 7 wherein the digital media stream further comprises a VoIP stream.

10. The apparatus of claim 7 wherein the digital media stream further comprises an IPTV stream.

11. The apparatus of claim 7 wherein transmitting the content of the first channel and the content of the second channel further comprises transmitting the content of the first channel and the content of the second channel time division multiplexed in the digital media stream.

12. The apparatus of claim 7 wherein transmitting the content of the first channel and the content of the second channel further comprises transmitting the content of the first channel and the content of the second channel frequency division multiplexed in the digital media stream.

13. A computer program product for provisioning bandwidth for a digital media stream, the digital media stream characterized by a bandwidth, the computer program product disposed in a computer readable, signal bearing medium, the computer program product comprising computer program instructions capable of:
monitoring, by a media display device, a user's viewing behavior to create a user profile;
transmitting, by the media display device to a media server, the user profile; and
responsive to receiving, by the media server from the media display device, a user selection of a first channel:
selecting, by the media server for transmission to the media display device, in dependence upon the user profile, at least one second channel;
adapting by the media server a first portion of the bandwidth for transmission of the content of the first channel and a second, smaller portion of the bandwidth for transmission of the content of the second channel; and
transmitting, multiplexed together in the digital media stream, by the media server to the media display device, the content of the first channel and the content of the second channel, the content of the second channel transmitted with a lower quality than the content of the first channel.

14. The computer program product of claim 13 wherein the signal bearing medium comprises a recordable medium.

15. The computer program product of claim 13 wherein the signal bearing medium comprises a transmission medium.

16. The computer program product of claim 13 wherein the user profile further comprises:
a history of user channel selections, each user channel selection characterized by a day of the week and a time;
the user's preference for types of content;
a history of the user's picture-in-picture use; and
the user's preset channels on a remote control.

17. The computer program product of claim 13 wherein the digital media stream further comprises a VoIP stream.

18. The computer program product of claim 13 wherein the digital media stream further comprises an IPTV stream.

19. The computer program product of claim 13 wherein transmitting the content of the first channel and the content of the second channel further comprises transmitting the content of the first channel and the content of the second channel time division multiplexed in the digital media stream.

20. The computer program product of claim 13 wherein transmitting the content of the first channel and the content of the second channel further comprises transmitting the content of the first channel and the content of the second channel frequency division multiplexed in the digital media stream.
